(19) United States
(12) Patent Application Publication
(10) Pub. No.: US 2012/0049518 A1
(43) Pub. Date: Mar. 1, 2012

(54) SWITCHGEAR CUBICLE ARRANGEMENT

(75) Inventors: Klaus Bodenstein, Hong Kong S.A.R (CN); Detlef Lange, Oberhausen (DE); Dieter Rupprich, Ohne (DE)

(73) Assignee: Avantis Ltd, Hong Kong (CN)

(21) Appl. No.: 13/146,006

(22) PCT Filed: Nov. 19, 2009
(86) PCT No.: PCT/EP2009/065439

§ 371 Date: Nov. 11, 2011

(30) Foreign Application Priority Data
Jan. 23, 2009 (DE) 02009005959 8

(51) Int. Cl. H02P 9/04; H02B 7/00

(52) U.S. Cl. 290/44; 361/605

(57) ABSTRACT

In the case of a rotor of a generator of a wind power installation or of a wind energy installation having a pole wheel which rotates in a stator or around a stator and has a pole wheel housing (1, 9), the aim is to create a solution which provides a simplified assembly capability for switchgear cabinets to be installed in rotating components of a wind power installation, with the capability to reduce the assembly effort. This is achieved in that retaining surfaces and/or retaining areas (8) are formed in or at the pole wheel housing (1, 9) and switchgear cabinets having electrical control and/or switching elements, which are arranged therein and have components which carry out a switching movement to switch and/or break an electrically conductive connection, can be arranged and/or are arranged such that they also rotate thereon and/or therein.

The invention relates to a rotor of a generator of a wind power installation or of a wind energy installation having a pole wheel which rotates in a stator or around a stator and has a pole wheel housing.

Wind energy installations or wind power installations have components which rotate about a rotation axis on the tower, such as the wind rotor hub on which the blades are arranged, or the rotor of the generator which is arranged on or in the machine housing. In some cases, steel cabinets which are provided with electrical control or switching elements and control the, electrical devices of the wind energy installation, which frequently has no transmission, also rotate with these rotating components. By way of example, the blade control system or else pitch system is located in the wind rotor hub, and comprises electric motors which are in each case used with mechanical components in order to control the blades that are attached to the wind rotor hub. Each of the electric motors has an associated switchgear cabinet in order to operate it. The electric motors and the switchgear cabinets are arranged in a fixed position in the rotating hub and rotate with the hub around the rotation axis of the wind rotor hub. Like normal cabinets, the switchgear cabinets are in the form of a rectangular cuboid and, for space reasons, are aligned with their narrow faces parallel to the rotation axis. Electrical control and/or switching elements and components are normally arranged on a mounting plate and are then inserted with this mounting plate into a respective switchgear cabinet. A mounting plate such as this is then located on the broad face, which forms a rear wall of the cabinet, or forms a cabinet rear wall such as this. In this case, electrical components or parts such as contactors are generally arranged on the mounting plate such that their translational reciprocating movement takes place at right angles to the plane of the mounting plate, that is to say in the case of a mounting plate which is installed in a switchgear cabinet described above, in the direction towards the cabinet front face and back again in the direction of the cabinet rear wall, that is to say in a direction between the two broad faces of a cabinet. If a switchgear cabinet with a configuration such as this is now arranged with its narrow faces parallel to the rotation axis of a hub or of a generator, this leads to the electrical components which carry out the switching movement, for example contactors, being permanently subject to a different influence from the earth's gravity force during a rotational revolution. In the positions above and below the rotation axis, the earth's gravity force acts in and against the direction of the translational reciprocating switching movement of the respective control and/or switching elements, and in the positions to the side of the rotation axis of the wind rotor hub, the earth's gravity force then acts at right angles to the direction of the switching movement. In the first two positions, the earth's gravity force therefore significantly influences the switching movement, while it has no influence on the switching movement in the two other cases. Depending on the position of the respective switchgear cabinet, the respective switching and/or control element is therefore subject to a different influence from the earth's gravity force, and therefore to a different influence during its switching processes. This leads to a non-uniform load on the control and/or switching elements in the various switchgear cabinets, leading to different wear rates and therefore to different useful lives. In order to preclude any influence of the earth's gravity force on the switching movement of the control and/or switching elements, they would have to be arranged in a rotating arrangement such that the direction of the switching movement is always aligned parallel to the rotation axis. In order to avoid this problem, the switchgear cabinets are therefore arranged such that the narrow faces of the switchgear cabinets are aligned parallel to the rotation axis, with the control and/or switching elements then at the same time being arranged on these narrow side walls of the switchgear cabinets, as a result of which they can carry out their switching movement parallel to the rotational longitudinal axis. However, this involves a considerably greater amount of assembly effort, since there is less space on the narrow face surfaces than on the broad face surfaces of a steel cabinet. In addition, the arrangement of the control and/or switching element is thus located at a distance from the mounting plate, as a result of which additional wiring must be laid, installed and connected from the mounting plate, which is arranged on the broad-face rear wall of a steel cabinet, to the control and/or switching elements, in particular contactors, which are arranged on the narrow-face side walls. However, in the past, sufficient space has not been available in the embodiments according to the prior art for positioning the switchgear cabinets aligned in a different manner in the rotating components, such as the wind rotor hub.

The invention is based on the object of creating a solution which provides a simplified assembly capability for switchgear cabinets to be installed in rotating components of a wind power installation, with the capability to reduce the assembly effort.

In the case of a rotor of the type mentioned initially, this object is achieved according to the invention in that retaining surfaces and/or retaining areas are formed in or at the pole wheel housing and switchgear cabinets having electrical control and/or switching elements, which are arranged therein and have components which carry out a switching movement to switch and/or break an electrically conductive connection, can be arranged and/or are arranged such that they also rotate thereon and/or therein.

The invention therefore provides a solution capability which arranges switchgear cabinets on a rotor of a generator of a wind energy installation or wind power installation which in particular has no transmission, and therefore provides more and sufficient space for the construction and arrangement of switchgear cabinets to be placed in rotating components of the wind power installation.

According to one development of the invention, a particularly advantageous capability for the provision of the necessary space is created in that retaining surfaces and/or retaining areas for accommodating and/or forming the switchgear cabinets are formed in the rotor and/or pole wheel housing rear face which faces away from the stator. In the case of the modern physically large rotors and generators of wind power installations, the rear face of the rotors or pole wheels can be skilfully used as a space and location for the arrangement of switchgear cabinets, particularly when these rotors or pole wheels are designed as external rotors. In this case, the retaining areas may be both in the form of cavities which are accessible from the pole wheel outer surface of the pole wheel housing rear face and cavities which are accessible from the pole wheel inside of the pole wheel housing rear face.

In particular, as a result of the better space conditions that are created, it is then also possible that the switchgear cabinets are at least essentially in the form of a rectangular cuboid and are aligned with their larger side surfaces, the broad faces, pointing at least essentially parallel to the rotation axis of the pole wheel housing, and with their longitudinal axis are aligned essentially at right angles to the rotation axis of the pole wheel housing, as the invention provides in a further refinement. In this case, the broad faces are then arranged parallel to the rotation axis, such that these broad faces are easily accessible to personnel in the pod or in the machine housing on the tower of a wind power installation or wind energy installation, since the steel cabinets are then also arranged with their broad face pointing in the longitudinal direction of the pod or of the machine housing. When fitting mounting plates, which correspond approximately to the size of a broad face surface, this makes it possible to insert electrical control and/or switching elements arranged there together with the mounting plate into a switchgear cabinet, as a result of which there is no need for any additional wiring, as has been required until now of the prior art.

Furthermore, in this case, it is then particularly expedient if the retaining surfaces and/or retaining areas are of such a size that at least one mounting plate and/or switchgear cabinet rear face, which supports the electrical control and/or switching elements, preferably forms a broad face of a switchgear cabinet and in particular is at right angles to the rotation axis of the pole wheel housing, can be arranged and/or is arranged therein, as the invention likewise envisages. The retaining areas, which are in the form of cavities, may in this case have the same shape as the switchgear cabinets, such that the mounting plate just needs to be inserted therein, after which a switching cabinet rear face which closes the cavity may then also need to be fitted. However, in this case, it is also possible for the mounting plate at the same time to form the switchgear cabinet rear face which closes the cavity. This further reduces the assembly effort and production effort for the switchgear cabinets since five sides of the switchgear cabinet have already been formed in the pole wheel housing, as a cuboid retaining area in the form of a cavity that is closed on five sides.

In order to allow the electrical control and/or switching elements to be aligned advantageously differently with respect to the earth's gravity force acting on them depending on the angle position during a rotation revolution, the invention is furthermore distinguished in that the electrical control and/or switching elements each have moving components, in particular translationally moving components, for switching and/or breaking an electrically conductive connection in a switching movement direction, and these components are arranged in the switchgear cabinets and/or the switchgear cabinets are aligned such that the switching movement direction of the components is aligned at least essentially parallel to the rotation axis of the pole wheel housing.

In this case, it is then particularly advantageous if the control and/or switching elements which have components which carry out a switching movement are arranged in the switchgear cabinets with their switching movement direction aligned at least essentially at right angles to the larger side surfaces of the respective switchgear cabinet, as the invention likewise envisages.

One particularly advantageous refinement of the invention furthermore consists in that the rotor is in the form of an external rotor which surrounds an internal stator. In this case, the rotor rear face and therefore the pole wheel housing rear face can be designed and configured very well as a surface or location for the formation of the retaining areas or retaining surfaces for accommodating the switchgear cabinets.

The refinement according to the invention is particularly advantageous if the electrical control and/or switching elements are contactors, as the invention also envisages.

The creation of the arrangement capability according to the invention then allows contactors to be installed well while in a position which is not subject to the earth's gravity during rotation operation.

In particular, it is advantageous to arrange the switchgear cabinets which contain electrical components for control of the blades according to the invention, since the switchgear cabinets then rotate with the blades of the wind energy installation or wind power installation uniformly with the wind rotor hub and the rotor or pole wheel and are positioned and arranged in a fixed position in their relative position with respect to a respectively associated blade. The invention therefore furthermore provides that the switchgear cabinets and the electrical control and/or switching elements are a component of the blade control system (pitch system) of the wind power installation or wind energy installation.

Since the design of the rotor according to the invention can be implemented advantageously in particular in the case of wind energy installations or wind power installations which have no transmission, it is then furthermore advantageous to also at the same time associate the associated blades of the wind rotor with the rotor or the pole wheel with the switchgear cabinets of the blade control system arranged therein or thereon, and thus at the same time to design the rotor of the generator as a wind rotor to which the blades are fitted. The invention is therefore furthermore distinguished in that the blades of the wind rotor of the wind power installation or wind energy installation are arranged on or at the pole wheel housing. This makes it possible to considerably reduce the physical length of a wind energy installation or wind power installation which has no transmission. It is therefore possible to set the wind rotor back so far with respect to the supporting tower that the pole wheel housing which holds the blades and which then solely forms the hub of the wind rotor does not project any further in the direction of the rotor rotation axis overall than the generator formed from it, on the supporting tower.

In one refinement of the invention, it is then in this case also possible for the blades of the wind rotor to be arranged on an axial extension of the pole wheel housing. If the rotor or the pole wheel housing of the generator is mounted on a tubular or cylindrical stator arrangement, possibly with the axial extension on which the blades may possibly also be arranged, this makes it possible to achieve a major material and weight reduction. In this case, if the rotor of the generator is in the form of an external rotor, the magnets that are fitted to the rotor or pole wheel can be positioned very close to the winding of the stator, thus forming a relatively small, but constant, air gap between the rotor and the stator. Furthermore, this can then be used particularly advantageously for non-contacting transmission of electrical power between the stator and the rotor. The invention is therefore furthermore distinguished in that the rotor has power transmission means for non-contacting transmission of electrical power to and from the stator, which means interact with associated power transmission means of the stator, in which case the power transmission means supply the blade control system (pitch system) in particular with the required electrical power. In this case, the power transmission means may comprise at least one rectifier for conversion of the electrical power transmitted or to be transmitted to the rotor to a DC voltage. It is therefore then possible to transmit the required electrical power between the switchgear cabinets and the electric motors which control the blades, in a manner that is relatively free of losses. The electrical power is therefore in this case also transmitted without wear, since no transmission means are provided, such as sliprings. For example, when using rectifiers, the required electrical power for the electric motors, which are provided for blade angle adjustment of the individual blades or rotor blades and in particular are arranged in a fixed position on the pole wheel housing, as well as the electrical power required for the switchgear cabinets, can be transmitted, for example, in the form of direct current or DC voltage, with power being transmitted from the non-rotating stator to the rotating rotor in a non-contacting manner.

The arrangement according to the invention of the switchgear cabinets on or in the pole wheel housing furthermore means that the electrical control and/or switching elements are subject to a uniform magnetic field during rotation. This is particularly true when the pole wheel housing is provided with permanent magnets. Finally, in one refinement, the invention therefore also provides that the switchgear cabinets with the electrical control and/or switching elements used therein rotate uniformly with the produced electrical field and are subject to a permanent magnetic field, without any relative movement with respect to the magnetic field.

The invention will be explained in more detail in the following text with reference, by way of example, to a drawing, in which:

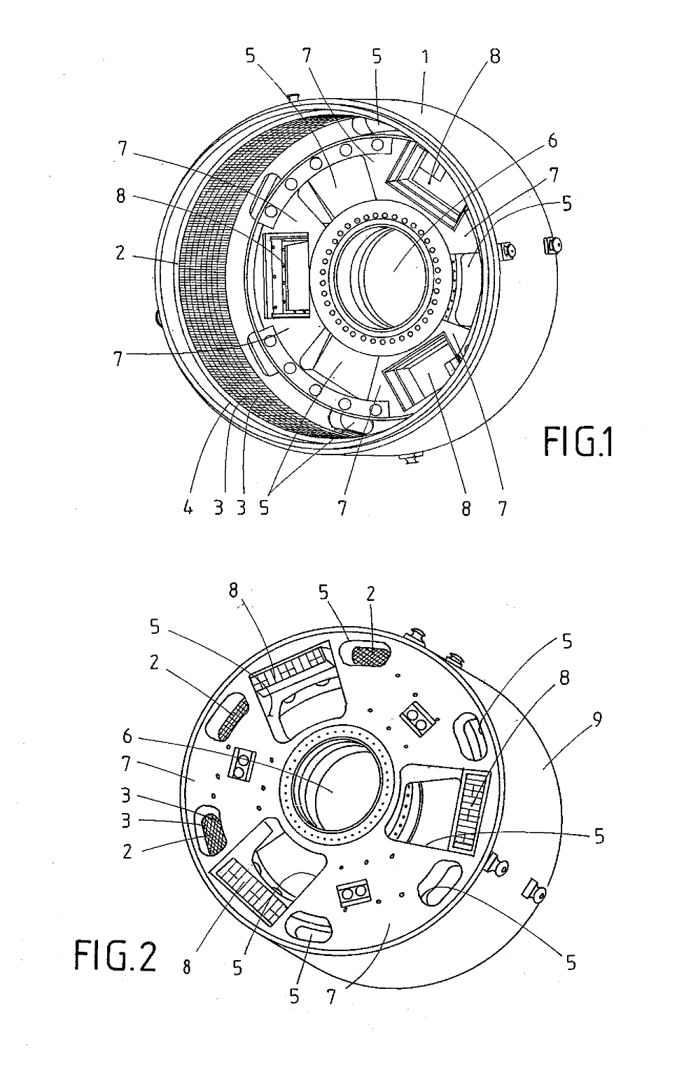

FIG. 1 shows a perspective illustration in the form of an internal view of a first exemplary embodiment of a pole wheel housing, and

FIG. 2 shows a perspective illustration in the form of an external view of a second exemplary embodiment of a pole wheel housing.

FIG. 1 shows a pole wheel housing 1 on whose internal circumferential surface a magnet wheel 2 is arranged. The magnet wheel 2 has a multiplicity of individual permanent magnets 3 which are arranged alongside one another and are arranged on the inside of a magnetic return-path ring 4. A pole wheel housing rear face 7 which is interrupted by apertures 5 and a central rotation shaft opening 6 and is in the form of a wall-like element is formed and arranged on one side of the pole wheel housing 1, within the circular cross-sectional area of the pole wheel 1. In the case of the pole wheel housing 1, which is provided to form an external rotor of a generator, this pole wheel housing rear face 7 is then positioned facing away from the stator, in its in-use position. Three retaining areas 8 in the form of rectangular cavities, which are closed on five sides, are formed in the pole wheel housing rear face 7. The retaining areas 8 are of such a size that they each accommodate one switchgear cabinet with electrical control and/or switching elements which are arranged therein and have components which carry out a switching movement in order to switch and/or break an electrically conductive connection, or even form this after closing of that side surface of the retaining areas 8 which is open to the inside of the pole wheel housing 1. For example, it is thus possible to arrange a mounting plate, which has the electrical control and/or switching elements, in these cavities such that this mounting plate closes the open broad face surface, with a switchgear cabinet thus being formed by means of the cavities. The electrical control and/or switching elements may be contactors, which are not illustrated, which are a component of the blade control system (pitch system) of a wind power installation or wind energy installation, with the pole wheel housing being a component of a generator of a wind power installation or wind energy installation which, in particular, has no transmission. The retaining areas 8 are positioned with respect to the rotation shaft, which is positioned in the rotation shaft opening 6 when the pole wheel housing 1 is in the installed position, such that their large broad face surfaces are aligned such that they point essentially parallel to the rotation axis of the pole wheel housing 1, and their longitudinal axis is aligned essentially at right angles to the rotation axis of the pole wheel housing 1. In this case, the electrical control and/or switching elements, which are not illustrated, are then furthermore arranged in the retaining areas 8 such that their respective, in particular at least essentially translational, reciprocating movement is likewise aligned at least essentially parallel to the rotation axis. In this case, the switching movement direction of the electrical control and/or switching elements is then aligned at right angles to the broad face surfaces.

The pole wheel housing 9 illustrated in FIG. 2 is designed and constructed essentially analogously to the pole wheel housing 1, so that the same reference symbols are used to denote the same elements here. The only difference is that the retaining areas 8 in the pole wheel housing 9 have a side surface which is open towards the outside, such that a mounting plate can be inserted therein from the outside of the pole wheel 9, while the retaining areas 8 of the pole wheel housing 1 are accessible from the opposite inner face to this of the pole wheel housing 1.

The blades of the wind rotor of the wind power installation or wind energy installation can be arranged in a manner which is not illustrated on or at the radial outer surface of the pole wheel housing 1, 9, such that the pole wheel housing then forms both the rotor of the generator and the wind rotor of the wind power installation. Welded-on or flange-connected tubular connecting stubs or tubular attachments can be provided on the outer surface of the pole wheel housing 1, 9 for attachment of the blades. However, it is also possible to provide an axial extension of the radial external circumferential surface of the pole wheel housing 1, 9, and to arrange the blades on this extension. Since the blades must be adjustable and are equipped with a blade control system, it is possible to also arrange the electric motors which drive the blade control system in or on the pole wheel housings 1, 9, in addition to the switchgear cabinets which have the control and/or switching elements for a blade control system such as this. In this case, it then also possible, in a manner which is likewise not illustrated, for the electrical power supply which is required for operation of the electric motors and for operation of the control and/or switching elements to be transmitted in a non-contacting manner from the stator to the respective pole wheel housing 1, 9 of the rotor of the generator. Power transmission means, which are not illustrated in any more detail, are arranged for this purpose both on the stator and on the rotor, and interact in a respectively defined association. In this case, the power transmission means may comprise a rectifier for conversion of the electrical power which is to be transmitted or is transmitted to the rotor to a DC voltage.

1. Rotor of a generator of a wind power installation or of a wind energy installation having a pole wheel which rotates in a stator or around a stator and has a pole wheel housing, wherein retaining surfaces and/or retaining areas are formed in or at the pole wheel housing and switchgear cabinets having electrical control and/or switching elements, which are arranged therein and have components which carry out a switching movement to switch and/or break an electrically conductive connection, can be arranged and/or are arranged such that they also rotate thereon and/or therein.

2. Rotor according to claim 1, wherein retaining surfaces and/or retaining areas for accommodating and/or forming the switchgear cabinets are formed in the rotor and/or pole wheel housing rear face which faces away from the stator.

3. Rotor according to claim 1, wherein the switchgear cabinets are at least essentially in the form of a rectangular cuboid and are aligned with their larger side surfaces, the broad faces, pointing at least essentially parallel to the rotation axis of the pole wheel housing, and with their longitudinal axis are aligned essentially at right angles to the rotation axis of the pole wheel housing.

4. Rotor according to claim 1, wherein the retaining surfaces and/or retaining areas are of such a size that at least one mounting plate and/or switchgear cabinet rear face, which supports the electrical control and/or switching elements can be arranged and/or is arranged therein.

5. Rotor according to claim 1, wherein the electrical control and/or switching elements each have moving components for switching and/or breaking an electrically conductive connection in a switching movement direction, and these components are arranged in the switchgear cabinets and/or the switchgear cabinets are aligned such that the switching movement direction of the components is aligned at least essentially parallel to the rotation axis of the pole wheel housing.

6. Rotor according to claim 1, wherein the control and/or switching elements which have components which carry out a switching movement are arranged in the switchgear cabinets with their switching movement direction aligned at least essentially at right angles to the larger side surfaces of the respective switchgear cabinet.

7. Rotor according to claim 1, wherein the rotor is in the form of an external rotor which surrounds an internal stator.

8. Rotor according to claim 1, wherein the electrical control and/or switching elements are contactors.

9. Rotor according to claim 1, wherein the switchgear cabinets and the electrical control and/or switching elements are a component of the blade control system (pitch system) of the wind power installation or wind energy installation.

10. Rotor according to claim 1, wherein the blades of the wind rotor of the wind power installation or wind energy installation are arranged on or at the pole wheel housing.

11. Rotor according to claim 10, wherein the blades are arranged on or at an axial extension of the pole wheel housing.

12. Rotor according to claim 1, wherein the rotor has power transmission means for non-contacting transmission of electrical power to and from the stator, which means interact with associated power transmission means of the stator.

13. Rotor according to claim 12, wherein the power transmission means supply the blade control system (pitch system) with the required electrical power.

14. Rotor according to claim 12, wherein the power transmission means comprise at least one rectifier for conversion of the electrical power transmitted to the rotor to a DC voltage.

15. Rotor according to claim 1, wherein the electrical control and/or switching elements are subject to a uniform magnetic field during rotation.

16. Rotor according to claim 1, wherein the switchgear cabinets with the electrical control and/or switching elements used therein rotate uniformly with the produced electrical field and are subject to a permanent magnetic field, without any relative movement with respect to the magnetic field.

17. Rotor according to claim 4, wherein the mounting plate and/or switchgear cabinet rear face form a broad face of a switchgear cabinet.

18. Rotor according to claim 4, wherein the mounting plate and/or switchgear cabinet rear face are at right angles to the rotation axis of the pole wheel housing.

19. Rotor according to claim 5, wherein the moving components comprise translationally moving components.
